(19) United States
(12) Patent Application Publication
(10) Pub. No.: US 2026/0346386 A1
(43) Pub. Date: Nov. 5, 2026

(54) DEVICE FOR AUTOMATICALLY EXCHANGING INDEXABLE INSERTS FROM AN INDEXABLE MILL

(71) Applicant: GIMA-MACHINES, Aartselaar (BE)

(72) Inventor: Senne DE WIT, Antwerpen (BE)

(21) Appl. No.: 19/108,031

(22) PCT Filed: Aug. 31, 2023
(86) PCT No.: PCT/IB2023/058613

§ 371 Date: Feb. 28, 2025

(30) Foreign Application Priority Data
Sep. 2, 2022 (BE) BE2022/5699

(51) Int. Cl. B23P 19/06; B23C 5/10; B23C 5/22; B25J 11/00; B25J 15/06

(52) U.S. Cl. CPC B23P 19/06; B23C 5/109; B23C 5/2208; B25J 11/005; B25J 15/0616

(57) ABSTRACT

A device for automatically exchanging indexable inserts from an indexable mill comprising a milling bar onto which multiple indexable inserts are each attached by a screw is disclosed. The device has a robotic arm with a tool holder. The device further includes a screw manipulation device with a screwdriver for unscrewing a first screw from the milling bar, wherein the first screw attaches a first indexable insert onto the milling bar, and a screw gripper for gripping the unscrewed first screw. The device further comprises an indexable insert manipulation device with an indexable insert gripper for removing the first indexable insert from the milling bar after the first screw has been removed by the screw manipulation device, wherein both the screw manipulation device and the indexable insert manipulation device are provided on the tool holder of the same robotic arm.

### TECHNICAL DOMAIN

The present patent application relates to a device for automatically exchanging indexable inserts from an indexable mill, wherein the indexable mill comprises a milling bar onto which multiple indexable inserts are each attached by means of a screw. The present invention relates in particular to a device for automatically exchanging indexable inserts from a long cutting edge mill.

### BACKGROUND OF THE INVENTION

Indexable insert mills are known in the art. In particular, long cutting edge mills (known as “Shell End Mills”) provided with indexable inserts are known in the art, for example form the patent publication WO2019030862 or from the commercial exploitation of the Stellram 5230VS Series mill by Kennametal. Such long cutting edge mills ale also known as mantle head mills.

An indexable mill comprises a milling bar onto which multiple indexable inserts are each removably affixed by means of a screw. Long cutting edge mills comprise a plurality of elongated spiral guides on the milling bar, wherein the indexable inserts are placed in the spiral guides. Indexable inserts are elements provided with multiple cutting edges arranged for machining workpieces. Indexable inserts are also known as cutting inserts. The indexable inserts comprise a top surface, a bottom surface and multiple side surfaces (for example three in the case of triangular indexable inserts, or four in the case of square indexable inserts) connecting the top surface to the bottom surface. The indexable inserts are provided with a screw passage extending between the top surface and the bottom surface, into which a screw can be inserted so as to couple the indexable insert to the milling bar of the indexable mill. The indexable inserts may also be uncoupled from the milling bar in order to exchange the indexable inserts for new indexable inserts (i.e. the indexable insert is replaced) or for the same indexable insert in a different orientation (i.e. the indexable insert is pivoted). In this way, indexable inserts may for example be provided that are optimally adapted to the application of the mill, for example by providing indexable inserts made from a suitable material. The use of indexable inserts on cutting tools has also led to an increased growth of productivity in the modern machining industry. This is due to its biggest advantage, the fact that cutting tools no longer need to be sharpened. The indexable inserts are exchanged when they have become dull, leading to lower tool costs since the holder, i.e. the milling bar, is substantially not subject to wear. Indexable inserts come in different forms, but the most common are square indexable inserts. Since each of such indexable inserts has four cutting edges, it can be pivoted four times before reaching the end of its life cycle. Only in the case of the first indexable inserts on the milling bar will two cutting edges be used at once, as a result of which they will require replacement more quickly. The screw with which the indexable insert is attached will also need to be replaced along with it after four times. When exchanging the indexable insert the screw first needs to be unscrewed, after which the screw and indexable insert are held in place. Then, the indexable insert is replaced or pivoted. In the case of pivoting, depending on its position on the mill, it should be pivoted over 90° or 180°.

Replacing the indexable inserts does however entail high labor costs, making it interesting for businesses making significant use of indexable inserts to automate this replacement process. A device for automating this replacement process is known from the patent publication EP3065912. This device from the state of the art however has a complex structure, wherein an immobile screw manipulation device and an indexable insert manipulation device act on an indexable mill carried by a robotic arm.

### DESCRIPTION OF THE INVENTION

It is a first aim of the present invention to provide a device for automatically exchanging (i.e. replacing or pivoting) indexable inserts from an indexable mill wherein the indexable mill comprises a milling bar onto which multiple indexable inserts are each attached by means of a screw, wherein the device has a less complex structure. To this end, a device is provided in accordance with the first claim. The device according to the first claim is a device for automatically exchanging indexable inserts from an indexable mill, preferably from a long cutting edge mill provided with indexable inserts, wherein the indexable mill comprises a milling bar onto which multiple indexable inserts are each attached by means of a screw. The device is provided with the following elements.
The device is provided with a robotic arm, wherein the robotic arm is provided with a tool holder. The robotic arm is for example made up of a sequence of pieces that extend between a primary end and a secondary end, and wherein consecutive pieces are connected rotatably relative to each other by rotary connection of a primary and a secondary end, wherein the primary end of the first piece has a fixed position and wherein the secondary end of the final piece comprises the tool holder. A commercially available robotic arm is for example the Fanuc LR Mate 200iD robot.
The device is further provided with a screw manipulation device, wherein the screw manipulation device is provided with a screwdriver. The screwdriver is arranged for manipulating a first screw in the milling bar, wherein the first screw attaches a first indexable insert onto the milling bar. Manipulating the first screw by means of the screwdriver comprises screwing and/or unscrewing the first screwdriver into or out of the milling bar so as to attach the first indexable insert to the milling bar or remove it from the milling bar, respectively. The screw manipulation device is further provided with a screw gripper for gripping the first screw, i.e. the first screw which is unscrewed and/or to be screwed in.
The device is further provided with an indexable insert manipulation device, wherein the indexable insert manipulation device comprises an indexable insert gripper for manipulating, for example removing and/or affixing, the first indexable insert to the milling bar, for example after the first screw has been removed by means of the screw manipulation device and/or before the first screw is affixed by means of the screw manipulation device, respectively.

In the device according to the present invention, both the screw manipulation device and the indexable insert manipulation device are provided on the tool holder of the same robotic arm. The present invention thus offers the advantage that a single, centrally arranged robotic arm can reach the milling bar, can manipulate the first screw and first indexable insert, can transfer the removed first screw and first indexable insert to a further work station where the first indexable insert is exchanged, i.e. replaced or pivoted, and where optionally the first screw is replaced, and after which the same robotic arm can affix the exchanged first indexable insert to the milling bar again by means of the first screw, which either has or has not been replaced. The device according to the present invention has a particularly simple structure.

In the further description of embodiments of the invention, the embodiments are described in the context of unscrewing and removing the first screw and the first indexable insert, respectively. However, the embodiments, mutatis mutandis, are also directed to the inverse manipulation, i.e. screwing in and affixing the first screw and the first indexable insert, respectively.

In the following, embodiments will be discussed relating specifically to the screw manipulation device.

According to an embodiment of the present invention, the screw manipulation device further comprises a first spring mechanism, wherein the screwdriver, i.e. at least the bit contacting the first screw, is arranged to be resilient in relation to the tool holder by means of the first spring mechanism. This offers the advantage that the screwdriver is arranged in such a way that the screwdriver is able to unscrew the first screw from the milling bar without needing to move the robotic arm, for example due to the bit of the screwdriver maintaining contact with the first screw by means of the spring action. Preferably, the indexable insert manipulation device takes up a fixed position relative to the tool holder. This offers the advantage that the indexable insert manipulation device is arranged in such a way that the indexable insert gripper maintains contact with the indexable insert during the unscrewing of the first screw.

According to an embodiment of the present invention, the first spring mechanism allows a translation of the screwdriver in a direction lying in line with the screwing axis of the screwdriver. According to a further embodiment, the allowed translation at least comprises a range of 5 mm, preferably 8 mm, with further preference 10 mm. Preferably, the range at least corresponds to the depth the screw is screwed into the milling bar.

According to an embodiment of the present invention, the screw manipulation device further comprises a second spring mechanism, wherein the screw gripper is arranged to be resilient in relation to the tool holder by means of the second spring mechanism. This offers the advantage that the screw gripper is arranged in such a way that the screwdriver is able to unscrew the first screw from the milling bar while the screw gripper maintains contact with the first screw. Preferably, the indexable insert manipulation device takes up a fixed position relative to the tool holder. This offers the advantage that the indexable insert manipulation device takes up a position such that the indexable insert gripper maintains contact with the indexable insert during the unscrewing of the first screw. According to an embodiment of the present invention, the second spring mechanism allows a translation of the screw gripper in a direction parallel to the translation direction of the first spring mechanism, for example lying in line with the screwing axis of the screwdriver. According to a further embodiment, the allowed translation at least comprises a range of 5 mm, preferably 8 mm, with further preference 10 mm. Preferably, the range at least corresponds to the depth the screw is screwed into the milling bar.

According to an embodiment of the present invention, the screw manipulation device further comprises an actuator, wherein the screw manipulation device is connected to the tool holder by means of the actuator. This offers the advantage that the screw manipulation device is arranged in such a way that by actuating the actuator, the unscrewed first screw can be moved between a first position, in which the first screw is substantially adjacent to the milling bar, and a second position, in which the first screw is removed from the milling bar. Preferably, the indexable insert manipulation device takes up a fixed position relative to the tool holder. This offers the advantage that the indexable insert manipulation device can take up a position such that the indexable insert gripper maintains contact with the indexable insert during the movement of the first screw between the first position and the second position by actuating the actuator.

According to an embodiment of the present invention, the first spring mechanism is arranged between the actuator and the screwdriver, i.e. at least the bit of the screwdriver. According to an embodiment of the present invention, the second spring mechanism is arranged between the actuator and the screw gripper.

According to an embodiment of the present invention, the actuator is a linear actuator. Preferably, the linear actuator carries out a translation parallel to the translation direction of the first spring mechanism. According to an embodiment of the present invention, the actuator is a pneumatic actuator, preferably a linear pneumatic actuator.

According to an embodiment of the present invention, the screw gripper is a negative pressure-based gripper. In indexable mills, it is customary to use non-ferromagnetic screws. Thus, for example, titanium screws are often used that are not magnetically attractable. The present embodiment offers the advantage that such screws can be gripped by the screw gripper without therefore requiring a mechanical actuation of the screw gripper, i.e. for example by providing the screw gripper with a pincer. Movable parts used in mechanical actuation are undesirable due to their higher replacement rate and due to their large dimensions. Preferably, the screw gripper is arranged to exert a suction force of at least 0,2 N onto the first screw. The inventors of the present patent application have found that at least 0,2 N suction force is required for suctioning conventional screws used in indexable insert mills, i.e. for example titanium screws.

According to an embodiment of the present invention, the screw gripper is provided with a hollow screw suction head. The screw suction head is connected to a negative pressure generating device so as to generate a negative pressure in the cavity of the screw suction head. Preferably, the negative pressure generating device is a “high suction rate” generator type. High suction rate types will be able to suction off a certain volume of air quicker than a “high vacuum” generator type, but will typically reach a negative pressure that is about 20% lower (at a same working pressure). This higher rate will be able to generate a larger suction force even with a lower quality seal. Preferably, the screw suction head ends in a screw suction opening located in a plane, i.e. in an opening delimited by edges of the screw suction head. The screw suction opening is delimited by an outer closed edge and preferably also by an inner closed edge (wherein the surface defined by the outer closed edge at least includes the surface defined by the inner closed edge). The outer closed edge is preferably circular, so as to provide a good fit with the usually circular head of a screw. The inner closed edge of the screw suction opening may be omitted, i.e. there may not be an inner edge. This is in particular possible if the screwdriver extending, as described below, through a passage in screw suction head, fits closely to the passage so that the vacuum is not broken by possible leaks between the screwdriver and its passage through the screw suction head. This is further described in the next paragraph. If, on the other hand, an inner closed edge is provided, it is preferably circular, in other words, the screw suction opening in that case is preferably an annular opening, wherein the inner and outer closed edges are substantially circular and concentric. An annular screw suction opening offers the advantage that it makes good use of the available screw surface area and is at the same time usable for screws having different kinds of engagement means. The screw suction opening is in communication with the cavity in the screw suction head, in particular so as to expose the screw suction opening to the vacuum in the cavity. The screw suction head is arranged to be positioned with the screw suction opening on top of the head of the first screw so that the negative pressure in the cavity of the screw suction head suctions the first screw via the screw suction opening and so that the engagement means in the head of the first screw for engaging the screw by means of the screwdriver remain accessible to the screwdriver. The engagement means in the head of the first screw for engaging the screw by means of the screwdriver consists of one or more grooves provided in the head of the first screw, wherein the grooves may for example present a cross-shaped structure or a Torx structure.

According to an embodiment of the present invention, the screw suction head is formed around a passage, preferably a cylindrical passage. The screwdriver extends in line with the screwing axis through this passage. Preferably, the inner closed edge of the screw suction opening delimits the passage. As discussed above, if no inner closed edge is provided in the screw suction opening, the fit between the passage and the screwdriver is so tight that vacuum leaks between the screwdriver and the passage are limited. To this end, the screwdriver is for example permanently in contact with the passage. The fit can in particular be made very tight when both the screw gripper (and thus the passage in the screw suction head) and the screwdriver are arranged to be resilient, i.e. by means of the second and first spring mechanism, respectively. This is because in that case, the screw gripper (and thus the passage in the screw suction head) and the screwdriver will translate together, which simplifies the formation of a tight fit. Omitting the inner closed edge of the screw suction opening offers the advantage that a larger portion of the surface area of the screw head can be used for exerting the suction force onto the first screw. Indeed, the usable surface of the screw head in that case covers the entire surface of the screw head within the outer closed edge of the screw suction opening, except for the part of the screw head delimited by the screwdriver being in contact with the engagement means of the screw head. According to an embodiment of the present invention, the first screw is made from a non-ferromagnetic material. Preferably, the first screw is made from a titanium-based alloy, preferably arranged not to permanently deform at a torque of 3,1 Nm. Such screws are usually used for affixing indexable inserts to the milling bar.

In the following, embodiments will be discussed relating specifically to the indexable insert manipulation device.

According to an embodiment of the present invention, the position of the indexable insert manipulation device relative to the tool holder is constant, i.e. the indexable insert manipulation device is preferably not connected to the tool holder by means of a spring arrangement or by means of an actuator.

According to an embodiment of the present invention, the indexable insert gripper is a negative pressure-based gripper. In indexable mills, non-ferromagnetic indexable inserts are usually used. In particular, indexable inserts that are not magnetically attractable are usually used. The present embodiment offers the advantage that such indexable inserts can be gripped by the indexable insert gripper without therefore requiring a mechanical actuation of the indexable insert gripper, i.e. for example by providing the indexable insert gripper with a pincer. Movable parts used in mechanical actuation are undesirable due to their higher replacement rate and due to their large dimensions. Preferably, the indexable insert gripper is arranged to exert a suction force of at least 2,5 N onto the first indexable insert. The inventors of the present patent application have found that at least 2,5 N suction force is required for suctioning conventional indexable inserts used in indexable insert mills.

According to an embodiment of the present invention, the indexable insert gripper is provided with a hollow indexable insert suction head. The indexable insert suction head is connected to a negative pressure generating device so as to generate a negative pressure in the cavity of the indexable insert suction head. Preferably, the negative pressure generating device is a “high suction rate” generator type. High suction rate types will be able to suction off a certain volume of air quicker than a “high vacuum” generator type, but will typically reach a negative pressure that is about 20% lower (at a same working pressure). This higher rate will be able to generate a larger suction force even with a lower quality seal. Preferably, the indexable insert suction head ends in a first indexable insert suction opening located in a plane, i.e. in an opening delimited by edges of the indexable insert suction head. This indexable insert suction opening is in communication with the cavity in the indexable insert suction head, for example so as to expose the first indexable insert suction opening to the vacuum in the cavity. This first indexable insert suction opening is delimited by an outer closed edge and preferably further delimited by an inner closed edge (wherein the surface defined by the outer closed edge at least includes the surface defined by the inner closed edge). As described above, an indexable insert comprises a top surface, a bottom surface and multiple side surfaces (for example three in the case of triangular indexable inserts, or four in the case of square indexable inserts) connecting the top surface to the bottom surface. The indexable inserts are provided with a screw passage, preferably cylindrical, extending between the top surface and the bottom surface, into which a screw can be inserted so as to couple the indexable insert to the milling bar of the indexable mill. Preferably, the inner closed edge of the first indexable insert suction opening, if present, is similar in shape, preferably substantially congruent, to the shape of the screw passage in the top surface of the first indexable insert. The inner closed edge of the first opening is for example substantially circular. Preferably, the outer closed edge of the first opening is a polygon. Preferably, the shape of the polygon formed by the outer closed edge is similar in shape, preferably substantially congruent, to the shape of the top surface of the first indexable insert. The outer closed edge of the first opening is for example substantially rectangular or triangular. The indexable insert suction head is arranged to be positioned with the first indexable insert suction opening on top of the top surface of the first indexable insert so that the negative pressure in the cavity of the indexable insert suction head suctions the first indexable insert via the first indexable insert suction opening and so that the screw passage through the first indexable insert, and ending in the top surface of the first indexable insert, remains accessible for insertion and removal of the first screw by means of the screw manipulation device.

According to an embodiment of the present invention, the indexable insert suction head is formed around a passage. The passage is preferably delimited by the inner closed edge of the first indexable insert suction opening, if present. The passage of the indexable insert suction head is preferably shaped in such a way that the screw manipulation device can contact the first screw through the passage, in particular using the engagement means in the head of the first screw. The passage of the indexable insert suction head is preferably substantially shaped as a cylinder or as a truncated cone of which the axial direction is in line with the screwing axis of the screwdriver.

According to an embodiment of the present invention, the indexable insert suction head additionally (i.e. supplementary to the first opening described above) ends in a second indexable insert suction opening located in a plane, in communication with the cavity in the indexable insert suction head, in particular so as to expose the second indexable insert suction opening to the vacuum in the cavity. The second indexable insert suction opening is preferably located in a plane that is substantially perpendicular to the plane in which the first indexable insert suction opening is located. The indexable insert suction head is arranged to be positioned with the second indexable insert suction opening on top of a side surface of the first indexable insert so that the negative pressure in the cavity of the indexable insert suction head suctions the first indexable insert via the first indexable insert suction opening and the second indexable insert suction opening. The second indexable insert suction opening is preferably only delimited by a closed outer edge that is preferably similar in shape, with further preference congruent, to the (at least one) side surface of the indexable insert. The closed outer edge of the second indexable insert suction opening for example has a rectangular shape. In a further embodiment of the present invention, the indexable insert suction head additionally ends in further indexable insert suction openings similar to the second indexable insert suction opening, wherein the further indexable insert suction openings are arranged to be positioned onto the other side surfaces of the indexable insert.

According to an embodiment of the present invention, the indexable insert manipulation device comprises a fixed part connected to the tool holder, wherein the indexable insert manipulation device further comprises an interchangeable part connected to the fixed part. Preferably, the interchangeable part of the indexable insert manipulation device comprises the first opening of the indexable insert suction head. Preferably, the interchangeable part of the indexable insert manipulation device also comprises the second (and any further) opening of the indexable insert suction head. This offers the advantage that the device can be adjusted for manipulating different kinds of indexable inserts by merely exchanging an interchangeable part of the indexable insert suction head. In an embodiment, the cavity of the indexable insert suction head extends over both the interchangeable part and part of the fixed part. Preferably, a sealing ring is provided between the fixed part and the interchangeable part. In particular, the sealing ring ensures a leak-free transition from the cavity in the interchangeable part to the fixed part.

According to an embodiment of the present invention, the first indexable insert is a carbide indexable insert. Preferably, the indexable insert is provided with one of a TIN, TiCN or TiN coating, which coating is preferably applied according to the CVD principle. An example of such a commercially available indexable insert is the indexable insert “5230VS12” from the manufacturer Kennametal.

In the following, embodiments will be discussed relating specifically to general aspects of the device.

According to an embodiment of the present invention, the indexable insert mill is a long cutting edge mill.

According to an embodiment of the present invention, the device comprises the milling bar, i.e. instead of only being suited for manipulating a milling bar. According to an embodiment of the present invention, the device comprises the first indexable insert, i.e. instead of only being suited for manipulating the first indexable insert. According to an embodiment of the present invention, the device comprises the first screw, i.e. instead of only being suited for manipulating the first screw. According to the present embodiment, the first indexable insert is affixed to the milling bar by means of the first screw.

According to an embodiment of the present invention, the device is further provided with at least one, for example each, of the following workstations:
a reception base for receiving the indexable insert mill, wherein the reception base preferably comprises indexing means for rotating the indexable insert mill around an axis in line with the milling bar,
an indexable insert pivoting station for receiving an indexable insert and automatically pivoting the received indexable insert,
an indexable insert supply station for supplying a new indexable insert,
an indexable insert discarding station for receiving an indexable insert and discarding the received indexable insert,
a screw supply station for supplying a new screw, and
a screw discarding station for receiving a screw and discarding the received screw.

In the present embodiment, each of the provided workstations is located within the manipulation range of the robotic arm. Preferably, the milling bar comprises an RFID storing information on the number of previous pivots of its individual indexable inserts, and the device is further provided with an RFID reader for reading the RFID of the milling bar and for controlling the parts of the device in accordance with the information read.

It is a further aim of the present invention to provide an indexable insert manipulation device that is suitable for use in the device according to any of the previous claims for automatically exchanging indexable inserts from an indexable mill. The indexable insert manipulation device preferably comprises the features of the indexable insert manipulation device as already discussed above in the context of the device according to the present invention, as well as in the context of the embodiments of the device according to the present invention. Preferably, the indexable insert manipulation device comprises an indexable insert gripper for manipulating a first indexable insert on the milling bar, i.e. respectively removing and/or installing a first indexable insert after a first screw has been removed by means of a screw manipulation device and/or before the first screw is affixed by means of a screw manipulation device, respectively. Preferably, the indexable insert gripper is a negative pressure-based gripper, wherein the indexable insert gripper is preferably arranged for exerting a suction force of at least 2,5 N onto the first indexable insert. Preferably, the indexable insert gripper is provided with a hollow indexable insert suction head, wherein the indexable insert suction head is connected to a negative pressure generating device so as to generate a negative pressure in the cavity of the indexable insert suction head, wherein the indexable insert suction head ends in a first indexable insert suction opening located in a plane, in communication with the cavity in the indexable insert suction head. Preferably, the indexable insert suction head is arranged to be positioned with the first indexable insert suction opening on top of the top surface of the first indexable insert so that the negative pressure in the cavity of the indexable insert suction head suctions the first indexable insert via the first indexable insert suction opening and so that the screw passage through the first indexable insert and ending in the top surface of the first indexable insert remains accessible for insertion and removal of the first screw by means of a screw manipulation device. According to an embodiment of the present invention, the indexable insert manipulation device is provided on a tool holder arranged to be attached to a robotic arm, as already discussed above. According to a further embodiment of the present invention, the tool holder also comprises the screw manipulation device as already discussed above.

It is a further aim of the present invention to provide a screw manipulation device arranged on a tool holder that is suitable for use in a device according to any of the previous claims for automatically exchanging indexable inserts from an indexable mill. The screw manipulation device provided on a tool holder preferably comprises the features of the screw manipulation device provided on the tool holder as already discussed above in the context of the device according to the present invention, as well as in the context of the embodiments of the device according to the present invention. The screw manipulation device is preferably provided with a screwdriver for manipulating a first screw on the milling bar, wherein the first screw attaches a first indexable insert onto the milling bar, i.e. for unscrewing and/or screwing the first screw from and/or into the milling bar, respectively, and with a screw gripper for gripping the first screw, i.e. the first screw that has been unscrewed and/or is to be screwed, respectively. The screw manipulation device further preferably comprises a first spring mechanism, wherein the screwdriver is arranged to be resilient in relation to the tool holder by means of the first spring mechanism so that the screwdriver can screw the first screw out of or into the milling bar without the tool holder needing to be moved.

### FIGURES

FIGS. 1a and 1b respectively show a perspective view of the indexable insert mill and of the robotic arm according to an embodiment of the present invention.

FIG. 2a shows a detail view of the long cutting edge indexable insert mill as used in embodiments according to the present invention, and FIG. 2b shows a detail view of an indexable insert used for the same.

FIG. 3 shows a perspective view of the tool holder and the tools provided on the robotic arm from FIG. 1.

FIG. 4 shows a cross section in a side view of the tool holder and the tools shown in FIG. 3.

FIG. 5 shows the screw manipulation device shown in FIG. 4 wherein the screwdriver is shown in perspective and wherein the screw gripper is shown in cross section.

FIG. 6 shows a cross section of the indexable insert manipulation device shown in FIG. 4.

FIG. 7 shows a cross section of the assembly of the screw manipulation device and the indexable insert manipulation device shown in FIG. 4 wherein the first screw is also shown in perspective and the first indexable insert is shown in cross section.

### FIGURE DESCRIPTION

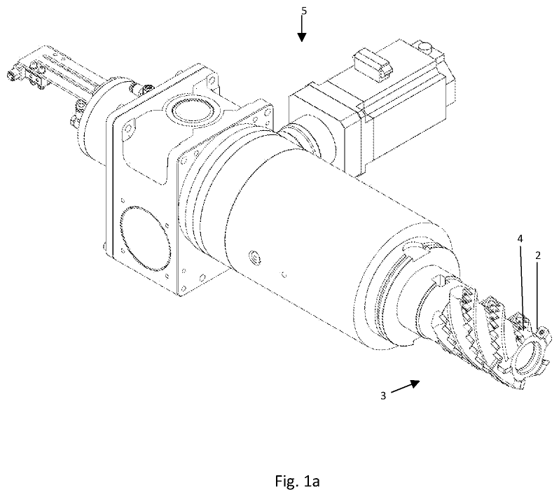

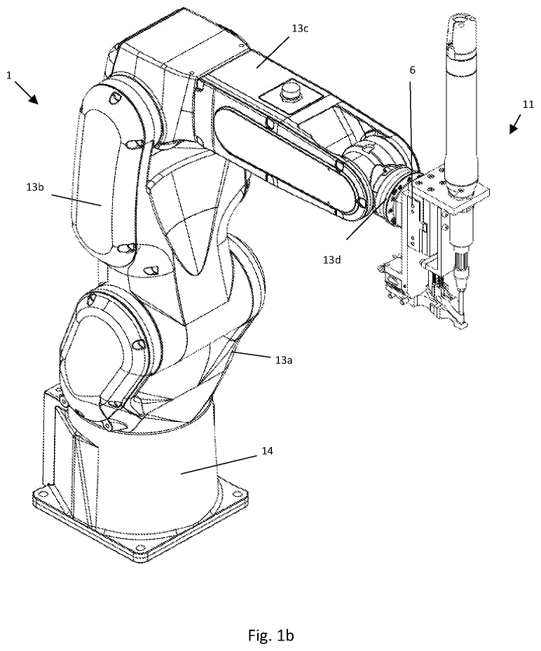

The present invention relates to a device comprising a robotic arm 1 for exchanging indexable inserts 2 on an indexable insert mill 3. FIGS. 1a and 1b respectively show a perspective view of the indexable insert mill 3 and of the robotic arm 1 according to an embodiment of the present invention. In the following, the intended use of the robotic arm 1 will first be discussed. The robotic arm 1 (hereafter also referred to as “primary robotic arm”, not to be confused with the “auxiliary robotic arm” introduced below) is positioned within reach of multiple workstations. An operator places a used indexable insert mill 3, i.e. the milling bar 4 provided with indexable inserts 2, into a loading station. From the RFID-tag, an RFID sensor detects which indexable insert mill 3 it is. Then, the indexable insert mill 3 is placed in the cleaning stand by an auxiliary robotic arm, after which the indexable insert mill 3 is cleaned. Next, the indexable insert mill 3 can be placed into the repository by the auxiliary robotic arm, in order to be clamped onto a reception base 5 later. The repository may also be skipped. When the indexable insert mill 3 has been clamped onto the reception base 5, the primary robotic arm 1 can start replacing or pivoting the indexable inserts 2. The primary robotic arm 1 is made up of a sequence of pieces 13a, 13b, 13c, 13d that each extend between a primary end and a secondary end, and wherein consecutive pieces are connected rotatably relative to each other by rotary connection of a primary and a secondary end, wherein the primary end of the first piece 13a has a fixed position due to being connected to a base 14, and wherein the secondary end of the final piece 13d comprises a tool holder 6 provided with tools 11. A commercially available robotic arm is for example the Fanuc LR Mate 200iD robot. With its tools 11 provided on the tool holder 6 of the robotic arm 1, the primary robotic arm 1, for each indexable insert 2, will:
remove the screw 7 from the milling bar 4,
remove the indexable insert 2 from the milling bar 4,
depending on the information stored in the RFID-tag, for example after a predetermined number of pivots of the present indexable insert 2:
   discard the indexable insert 2 via the indexable insert discarding station and retrieve a new indexable insert 2 via the indexable insert supply station, or
   pivot the indexable insert 2 via the indexable insert pivoting station,
depending on the information stored in the RFID-tag, for example after a predetermined number of pivots of the indexable insert 2, discard the screw 7 by which the present indexable insert 2 had been affixed via the screw discarding station and retrieve a new screw 7 via the screw supply station, and
screw the pivoted or newly retrieved indexable insert 2 tight again on the milling bar 4 by means of the old or the newly retrieved screw 7.

Next, the indexable insert mill 3 is taken out by the auxiliary robotic arm and measured in the presetting stand. These measurements are loaded into in the RFID-tag of the indexable insert mill 3 to later be used as tool parameters in the CNC-machine. Finally, the indexable insert mill 3 can be placed into the repository, ready for use, to later be taken out again by an operator. This last passage through the repository may also be skipped.

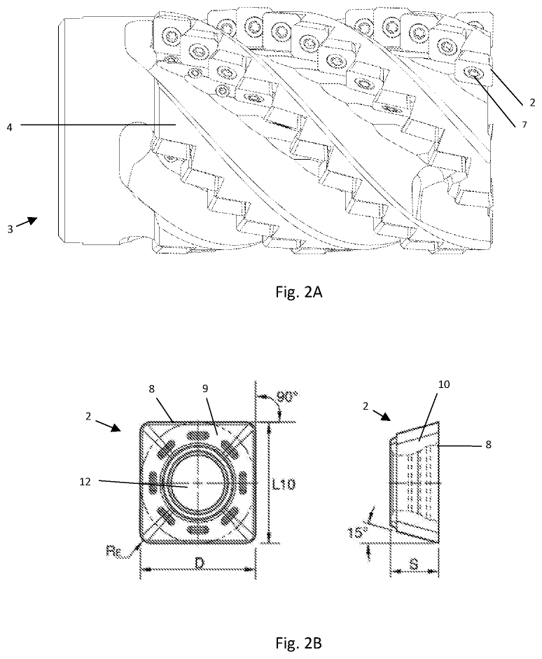

A long cutting edge mill 3 is shown in FIG. 2a, and a detail view of an indexable insert 2 used for the same is shown in FIG. 2b. As previously discussed, a long cutting edge mill is a type of indexable insert mill. The particular long cutting edge mill 3 shown is of the Stellram 5230VS Series type, manufactured by Kennametal, and is widely used in the aircraft industry for manufacturing titanium parts. The indexable insert mill 3 shown comprises a milling bar 4 onto which sixty indexable inserts 2 have each been screwed by means of an M4 titanium screw 7 with a tightening torque of 3,1 Nm. A Torx-20 bit mounts the screw 7 to 8 mm into the milling bar 4. The indexable inserts 2 shown are of the 5230VS12 type from the manufacturer Kennametal. These carbide indexable inserts 2 are used in harsh circumstances with high vibrations, heavy impacts and unstable conditions. They are ideal for machining titanium and stainless steel. The following parameters apply:
L10=12,70 mm (cutting length indexable insert)
D(IC)=12,70 mm (size indexable insert)
S=4,75 mm (thickness indexable insert)
Rϵ=1,194 mm (angle radius)

These indexable inserts 2 each have four cutting edges 8 formed by the edge between the top surface 9 and each of the sides 10 of the indexable insert 2. The indexable inserts are provided with a cylindrical screw passage 12 extending between the top surface 9 and the bottom surface, into which the screw 7 can be inserted so as to couple the indexable insert 2 to the milling bar 4 of the indexable mill 3. In the case of the top row indexable inserts 2, two cutting edges 8 are used at once, versus only a single cutting edge 8 for the other rows. Since each indexable insert 2 has four cutting edges 8, it can be pivoted four times before reaching the end of its life cycle. Only in the case of indexable inserts 2 on the top row of the milling bar 4 will two cutting edges 8 be used at once, as a result of which they will require replacement more quickly. The screw 7 with which the indexable insert is attached will also need to be replaced along with it after four times.

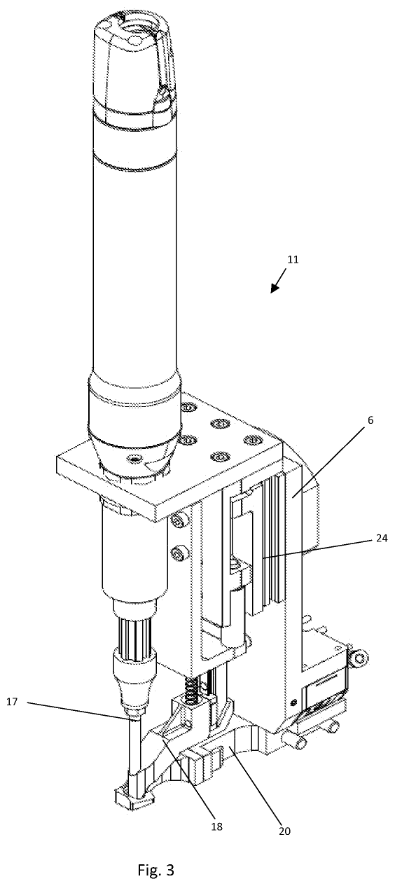

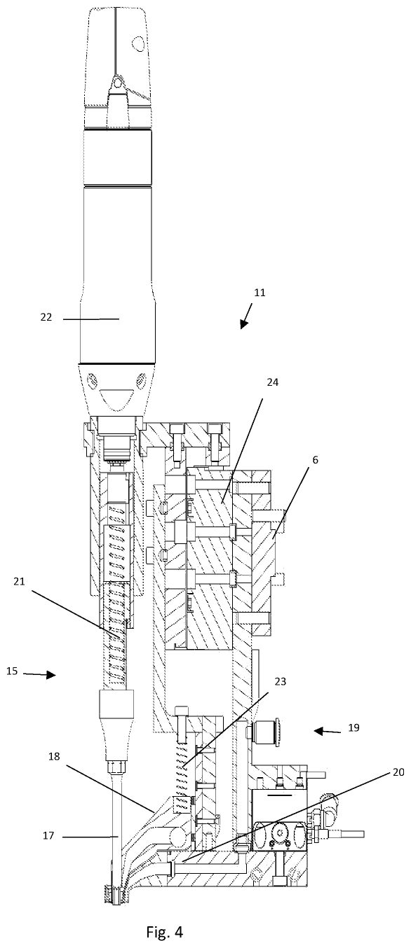

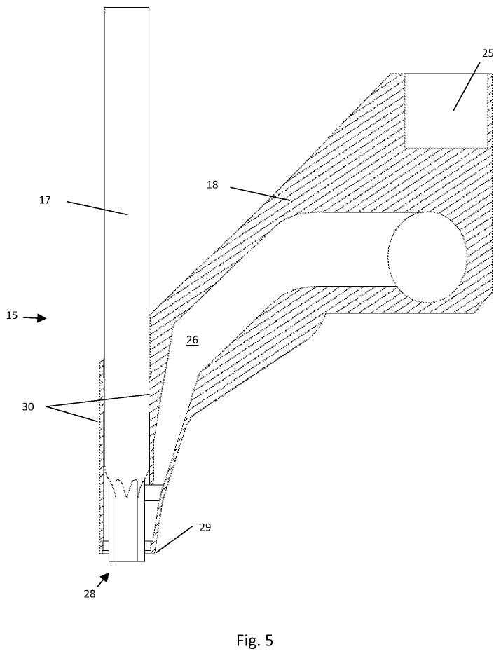

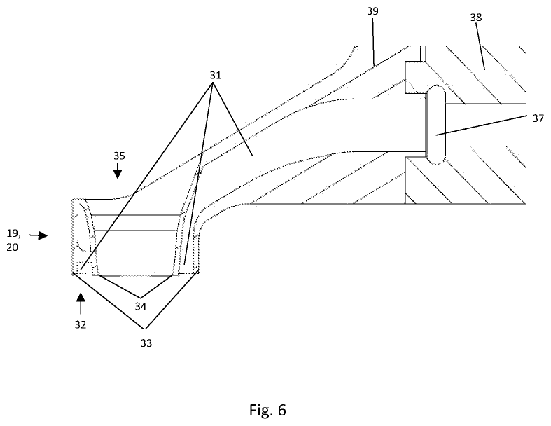

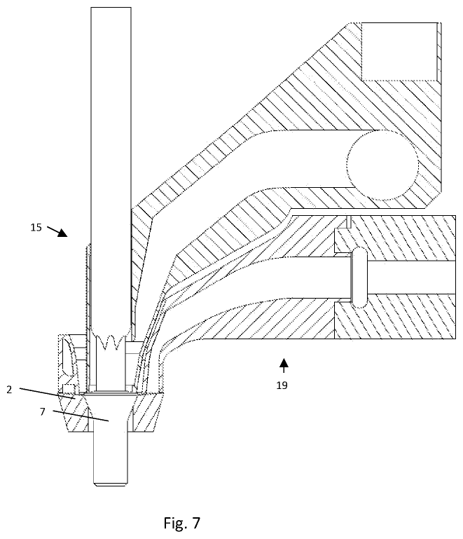

FIGS. 3-7 show a detailed view of the tools 11 mounted on the tool holder 6. The tools 11 comprise
a screw manipulation device 15 provided with a screwdriver 17. The screwdriver 17 is arranged for manipulating a first screw 7 in the milling bar 4, wherein the first screw 7 mounts a first indexable insert 2 onto the milling bar 4. Manipulating the first screw 7 by means of the screwdriver 17 comprises screwing and unscrewing the first screw 7 into or out of the milling bar 4 so as to attach the first indexable insert 2 to the milling bar 4 or remove it from the milling bar 4, respectively. The screw manipulation device 15 is further provided with a screw gripper 18 for gripping the first screw 7 which has been unscrewed and/or is to be screwed in.
an indexable insert manipulation device 19, wherein the indexable insert manipulation device 19 comprises an indexable insert gripper 20 for manipulating, i.e. removing and affixing, the first indexable insert 2 to the milling bar 4, for example after the first screw 7 has been removed by means of the screw manipulation device 15 and before the first screw 7 is affixed by means of the screw manipulation device 15, respectively.

The screw manipulation device 15 further comprises a first spring mechanism 21, wherein the bit of the screwdriver 17 is arranged by means of the first spring mechanism 21 to be resilient in relation to the tool holder 6. To his end, the first spring mechanism 21 comprises a spiral spring. It should be noted that the electric motor 22 driving the screwdriver 17 is arranged not to be resilient in relation to the tool holder 6. The screwdriver 17 is arranged in such a way by means of the first spring mechanism 21 that the screwdriver 17 can unscrew the first screw 7 from the milling bar 4 and screw it tight again without requiring the robotic arm 1 to be moved, for example due to the bit of the screwdriver 17 maintaining contact with the first screw 7 by means of the spring action, in particular while the screw moves up or down during unscrewing or screwing in. The indexable insert manipulation device 19 takes up a fixed position relative to the tool holder 6. This offers the advantage that the indexable insert manipulation device 19 is arranged in such a way that the indexable insert gripper 20 maintains contact with the indexable insert 2 during unscrewing and screwing in of the first screw 7. The first spring mechanism 21 allows a translation of the bit of the screwdriver 17 in a direction lying in line with the screwing axis of the screwdriver 17. The allowed translation has a range that is more than the screwed-in depth of the screw 7 in the milling bar 4. The screw manipulation device 15 further comprises a second spring mechanism 23, wherein the screw gripper 18 is arranged by means of the second spring mechanism 23 to be resilient in relation to the tool holder 6. To his end, the second spring mechanism 23 comprises a spiral spring which is mounted in a groove 25 of the screw manipulation device. The screw gripper 18 is arranged in such a way by means of the second spring mechanism 23 that the screwdriver 17 can unscrew the first screw 7 from the milling bar 4 or screw it tight while the screw gripper 18 maintains contact with the first screw 7, in particular while the screw moves up or down during unscrewing or screwing in. The second spring mechanism 23 allows a translation of the screw gripper 18 in a direction parallel to the translation direction of the first spring mechanism 21. The allowed translation comprises a range that is more than the screwed-in depth of the screw 7 in the milling bar 4. The screw manipulation device 15 further comprises a linear actuator 24, wherein the screw manipulation device 15 is connected to the tool holder 6 by means of the actuator 24. This offers the advantage that the screw manipulation device is arranged in such a way that by actuating the actuator 24, the unscrewed first screw 7 can be moved between a first position, in which the first screw 7 is substantially adjacent to the milling bar 4, and a second position, in which the first screw 7 is removed from the milling bar 4. The indexable insert manipulation device 19 takes up a fixed position relative to the tool holder 6, i.e. is not connected to the tool holder by means of the actuator 24 or any of the first or second spring mechanisms 21, 23. This offers the advantage that the indexable insert manipulation device 19 can take up a position such that the indexable insert gripper 20 maintains contact with the indexable insert 2 during the movement of the first screw 7 between the first position and the second position by actuating the actuator 24. The first spring mechanism 21 is arranged between the actuator 24 and the bit of the screwdriver 17. The second spring mechanism 23 is arranged between the actuator 24 and the screw gripper 18. This means that the springs in the first and second spring mechanisms 21 are not extended or compressed during actuation of the linear actuator 24. The linear actuator 24, upon actuation, carries out a translation parallel to the translation direction of the first spring mechanism 21.

The screw gripper 18 is a negative pressure-based gripper which is arranged to exert a suction force of at least 0,2 N onto the first screw 7. The screw gripper 18 is provided with a hollow screw suction head 26. The screw suction head 26 is connected to a negative pressure generating device (not shown) so as to generate a negative pressure in the cavity of the screw suction head 26. The screw suction head 26 ends in a screw suction opening 28 located in a plane, i.e. in an opening delimited by edges 29 of the screw suction head. The screw suction opening 28 is delimited by a circular outer closed edge 29. The screw suction opening 28 is in communication with the cavity in the screw suction head 26, in particular so as to expose the screw suction opening 28 to the vacuum in the cavity. The screw suction head 26 is arranged to be positioned with the screw suction opening 28 on top of the head of the first screw 7 so that the negative pressure in the cavity of the screw suction head 26 suctions the first screw 7 via the screw suction opening 28 and so that the engagement means in the head of the first screw 7 remain accessible to the screwdriver 17. The screw suction head 26 is formed around a cylindrical passage 30. The screwdriver 17 extends in line with the screwing axis through this passage 30. The fit between the passage 30 and the screwdriver 17 is so tight that vacuum leaks between the screwdriver 17 and the passage 30 are limited. To this end, the screwdriver 17 is in contact with the passage 30.

The indexable insert gripper 20 is a negative pressure-based gripper arranged to exert a suction force of at least 2,5 N onto the first indexable insert 2. The indexable insert gripper 20 is provided with a hollow indexable insert suction head 31. The indexable insert suction head 31 is connected to a negative pressure generating device so as to generate a negative pressure in the cavity of the indexable insert suction head 31. The indexable insert suction head 31 ends in an indexable insert suction opening 32 located in a plane, i.e. in an opening delimited by edges 33, 34 of the indexable insert suction head 31. This indexable insert suction opening 32 is in communication with the cavity in the indexable insert suction head 31, so as to expose the first indexable insert suction opening 32 to the vacuum in the cavity. This indexable insert suction opening 32 is delimited by a square-shaped outer closed edge 33 and further delimited by a circular inner closed edge 34. The inner closed edge 34 of the indexable insert suction opening 32 is substantially congruent to the shape of the screw passage 12 in the top surface 9 of the first indexable insert 2. The outer closed edge 33 of the opening 32 is substantially congruent to the shape of the top surface 9 of the first indexable insert 2. The indexable insert suction head 31 is arranged to be positioned with the indexable insert suction opening 32 on top of the top surface 9 of the first indexable insert 2 so that the negative pressure in the cavity of the indexable insert suction head 31 suctions the first indexable insert 2 via the first indexable insert suction opening 32 and so that the screw passage 12 through the first indexable insert 2 and ending in the top surface 9 of the first indexable insert 2 remains accessible for insertion and removal of the first screw 7 by means of the screw manipulation device 15. The indexable insert suction head 31 is formed around a passage 35 delimited by the inner closed edge 34 of the indexable insert suction opening 32. The passage 35 of the indexable insert suction head 31 is shaped in such a way that the screw manipulation device 15 can come into contact with the head of the first screw 7 through the passage 35. The passage 35 of the indexable insert suction head 31 is shaped as a truncated cone of which the axial direction is in line with the screwing axis of the screwdriver 17.

The indexable insert manipulation device 19 comprises a fixed part 38 that is connected to the tool holder 6, and further an interchangeable part 39 that is connected to the fixed part 38. The interchangeable part 39 of the indexable insert manipulation device 19 comprises the opening 32 of the indexable insert suction head 31. The cavity of the indexable insert suction head 31 extends over both the interchangeable part 39 and part of the fixed part 38. A sealing ring 37 is provided between the fixed part 38 and the interchangeable part 39, which ensures a leak-free passage from the cavity in the interchangeable part 39 to the fixed part 38.

1. device for automatically exchanging indexable inserts from an indexable mill wherein the indexable mill comprises a milling bar onto which multiple indexable inserts are each attached by means of a screw, wherein the device comprises:
a robotic arm, wherein the robotic arm comprises a tool holder;
a screw manipulation device, wherein the screw manipulation device is comprises a screwdriver for manipulating a first screw in the milling bar, wherein the first screw attaches a first indexable insert onto the milling bar; and
an indexable insert manipulation device, wherein the indexable insert manipulation device comprises an indexable insert gripper for gripping the first indexable insert,
wherein both the screw manipulation device and the indexable insert manipulation device are provided on the tool holder of the same robotic arm.

2. The device according to claim 1, wherein the screw manipulation device further comprises a first spring mechanism, wherein the screwdriver is arranged to be resilient in relation to the tool holder by means of the first spring mechanism so that the screwdriver is able to unscrew the first screw from the milling bar without needing to move the robotic arm, and wherein the indexable insert manipulation device preferably occupies a fixed position in relation to the tool holder so that the indexable insert gripper maintains contact with the indexable insert during an unscrewing of the first screw.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. The device according to claim 1, wherein a position of the indexable insert manipulation device relative to the tool holder is constant.

17. (canceled)

18. The device according to the claim 16, wherein the indexable insert gripper is provided with a hollow indexable insert suction head, wherein the indexable insert suction head is connected to a negative pressure generating device so as to generate a negative pressure in a cavity of the indexable insert suction head, wherein the indexable insert suction head ends in a first indexable insert suction opening located in a plane, in communication with the cavity in the indexable insert suction head, and wherein the indexable insert suction head is arranged to be positioned with the first indexable insert suction opening on top of a top surface of the first indexable insert so that the negative pressure in the cavity of the indexable insert suction head suctions the first indexable insert via the first indexable insert suction opening and so that a screw passage through the first indexable insert and ending in the top surface of the first indexable insert remains accessible for insertion and removal of the first screw by means of the screw manipulation device.

19. The device according to the claim 18, wherein the first indexable insert suction opening in the plane of the opening is delimited by an outer closed edge wherein an outer closed edge preferably forms a polygon and by an inner closed edge wherein the inner closed edge preferably forms a circle.

20. (canceled)

21. (canceled)

22. (canceled)

23. (canceled)

24. (canceled)

25. (canceled)

26. (canceled)

27. (canceled)

28. (canceled)

29. The device according to claim 1, wherein the device is further provided with at least one of the following workstations:
a reception base for receiving the indexable insert mill, wherein the reception base preferably comprises indexing means for rotating the indexable insert mill around an axis in line with the milling bar;
an indexable insert pivoting station for receiving an indexable insert and automatically pivoting the received indexable insert;
an indexable insert supply station for supplying a new indexable insert;
an indexable insert discarding station for receiving an indexable insert and discarding the received indexable insert;
a screw supply station for supplying a new screw; and
a screw discarding station for receiving a screw and discarding the received screw,
wherein each of the provided workstations is located within a manipulation range of the robotic arm.

30. (canceled)

31. An indexable insert manipulation device that is suitable for use in a device for automatically exchanging indexable inserts from an indexable mill, wherein the indexable mill comprises a milling bar onto which multiple indexable inserts are each attached by means of a screw and wherein the device comprises a robotic arm comprising a tool holder, a screw manipulation device for manipulating a first screw in the milling bar wherein the first screw attaches a first indexable insert onto the milling bar, and the indexable insert manipulation device, wherein both the screw manipulation device and the indexable insert manipulation device are provided on the tool holder of the same robotic arm, the indexable insert manipulation device comprising an indexable insert gripper for manipulating a first indexable insert on the milling bar, wherein the indexable insert gripper is a negative pressure-based gripper, wherein the indexable insert gripper is provided with a hollow indexable insert suction head, wherein the indexable insert suction head is connected to a negative pressure generating device so as to generate a negative pressure in a cavity of the indexable insert suction head, wherein the indexable insert suction head ends in a first indexable insert suction opening located in a plane, in communication with the cavity in the indexable insert suction head, and wherein the indexable insert suction head is arranged to be positioned with the first indexable insert suction opening on top of a top surface of the first indexable insert so that the negative pressure in the cavity of the indexable insert suction head suctions the first indexable insert via the first indexable insert suction opening and so that a screw passage through the first indexable insert and ending in the top surface of the first indexable insert remains accessible for insertion and removal of the first screw by means of a screw manipulation device, and wherein the indexable insert suction head is formed around a passage wherein the passage is shaped in such a way that the screw manipulation device can contact the first screw through the passage.

32. (canceled)

33. The indexable insert manipulation device according to claim 31, wherein the passage is substantially shaped as a cylinder or as a truncated cone of which an axial direction is in line with a screwing axis.

34. The indexable insert manipulation device according to claim 31, wherein the first indexable insert suction opening in the plane of the opening is delimited by an outer closed edge wherein an outer closed edge preferably forms a polygon.

35. The indexable insert manipulation device according to claim 31, wherein the first indexable insert suction opening in the plane of the opening is further delimited by an inner closed edge wherein the inner closed edge preferably forms a circle.

36. The indexable insert manipulation device according to claim 35, wherein the passage is delimited by the inner closed edge of the first indexable insert suction opening.

37. The indexable insert manipulation device according to claim 31, wherein the indexable insert suction head additionally ends in a second indexable insert suction opening located in a plane, in communication with the cavity in the indexable insert suction head, wherein the second indexable insert suction opening is located in a plane that is substantially perpendicular to the plane in which the first indexable insert suction opening is located, and wherein the indexable insert suction head is arranged to be positioned with the second indexable insert suction opening on top of a side surface of the first indexable insert so that the negative pressure in the cavity of the indexable insert suction head suctions the first indexable insert via the first indexable insert suction opening and the second indexable insert suction opening.

38. The indexable insert manipulation device according to claim 31, wherein the indexable insert manipulation device comprises a fixed part connected to the tool holder, and wherein the indexable insert manipulation device further comprises an interchangeable part connected to the fixed part.

39. The indexable insert manipulation device according to claim 38, wherein the interchangeable part of the indexable insert manipulation device comprises the first indexable insert suction opening of the indexable insert suction head.

40. The indexable insert manipulation device according to claim 39, wherein the cavity of the indexable insert suction head extends over both the interchangeable part and part of the fixed part, and wherein preferably a sealing ring is provided between the fixed part and the interchangeable part.
